(19) United States
(12) Patent Application Publication
(10) Pub. No.: US 2008/0242523 A1
(43) Pub. Date: Oct. 2, 2008

(54) Deflection Roller For a Traction Mechanism Drive

(75) Inventors: Hermann Stief, Emskirchen (DE); Scott Ribey, Herzogenaurach (DE); Christoph Schroeder, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 10/597,907

(22) PCT Filed: Dec. 22, 2004
(86) PCT No.: PCT/EP04/14581

§ 371 Date: Sep. 12, 2006

(30) Foreign Application Priority Data
Feb. 12, 2004 (DE) 10 2004 006 906.9

(51) Int. Cl. F16C 13/00; F16H 7/08

(52) U.S. Cl. 492/7

(57) ABSTRACT

A deflecting roller (1) for a traction mechanism drive is characterized in that a guide collar (10.5) of the spacer sleeve (10) is held by the holding bore (5.1) of the inner ring (5), and the guide collar (10.5) has a recess (10.4) in which an elastic holding element (11) is inserted, said elastic holding element (11) bearing against the holding bore (5.1) of the inner ring (5) under preload.

### FIELD OF THE INVENTION

The invention relates to a deflecting roller for a traction mechanism drive, composed of an annular body, against the lateral surface of which a traction mechanism, in particular a belt, bears, having a rolling bearing which is composed of an inner ring and an outer ring, wherein the outer ring is enclosed by a holding bore of the annular body, and the deflecting roller is fixed to a screw-on surface by means of a fastening screw which extends through a holding bore of the inner ring and a holding bore of a spacer sleeve, wherein the distance between the screw-on surface and the deflecting roller is determined by the axial extent of the spacer sleeve which is held against the deflecting roller by means of a transport securing means.

### BACKGROUND OF THE INVENTION

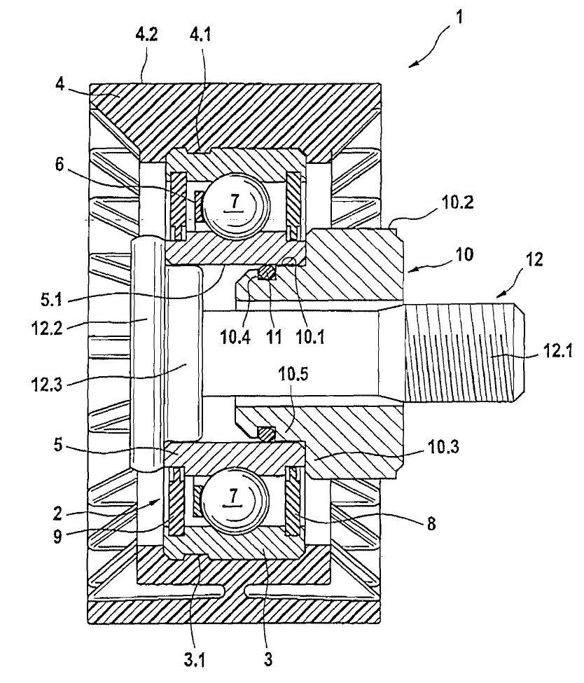

A deflecting roller of said type is previously known from DE 100 36 765 A1. According to FIG. 2, said deflecting roller is composed of an annular body, against the outer lateral surface of which a traction mechanism in the form of a belt bears. The holding bore of said annular body encloses the outer ring of a double-row deep groove ball bearing which is sealed off at both sides. The deflecting roller also includes a spacer element in the form of a disk, by means of which the axial distance between a screw-on surface on the engine and the center of the belt, which at the same time is the center of the rolling bearing, is equalized. The deflecting roller is held against the screw-on surface of the engine by means of a fastening screw, with said fastening screw passing through the inner bearing ring and the spacer sleeve. In order to prevent the fastening screw and the spacer element from becoming detached from the deflecting roller, a holding element is inserted in the holding bore of the inner bearing ring, said holding element engaging both around the fastening screw and also around the spacer element. In this way, the deflecting roller, the spacer element and the fastening screw are captively held together by means of the holding element which is inserted into the inner bearing ring.

A disadvantage of the above is that, in addition to the spacer element, the fastening screw itself is also captively held against the deflecting roller. This can prove obstructive when automatically fastening the tensioning roller to the fastening surface, because in some circumstances, the fastening screw is in the way.

A further generic deflecting roller for a traction mechanism drive is known from DE 100 43 840 A1. Said deflecting roller is fixed to the screw-on surface of the engine via a spacer sleeve by means of a fastening screw, wherein the fastening screw is held by the holding bore of the inner bearing ring, and therefore passes through said inner bearing ring and the spacer sleeve. In order to form a captively held assembly comprising the deflecting roller, the spacer sleeve and the fastening screw, the spacer sleeve is provided with radially inwardly directed caulkings which prevent the fastening screw from falling out axially. In this case, it is also disadvantageous that the fastening screw itself serves as a transport securing means.

### SUMMARY OF THE INVENTION

Proceeding from the disadvantages of the known technical solutions, the invention is therefore based on the object of securing the deflecting roller and the spacer sleeve to one another during transport without the fastening screw being used for this purpose.

According to the invention, said object is achieved according to the characterizing part of claim 1 in connection with its preamble in that a guide collar of the spacer sleeve is held by the holding bore of the inner ring, and the guide collar has a recess in which an elastic holding element is inserted, said elastic holding element bearing against the holding bore of the inner ring under preload.

The decisive advantage of the solution according to the invention is that the deflecting roller and the associated spacer sleeve are secured to one another for transport and/or captively without the fastening screw, which is necessary for fixing the deflecting roller to the screw-on surface, being used for this purpose. Said fastening screw is provided by the end consumer themselves, and therefore does not need to be initially removed from the deflecting roller in case that were to take up the space conditions during the assembly process. Further advantages are that, on the one hand, an additional holding element which encloses the fastening screw is no longer required, and on the other hand, no special fastening screws need be used as a result of the caulking between the spacer sleeve and the fastening screw not being required. A further advantage is the large tolerance range between the spacer sleeve and the holding bore of the inner bearing ring. Since the guide collar of the spacer sleeve is seated in the inner bearing ring by means of the elastic holding element, relatively large tolerate are possible between the diameter of the guide collar and the diameter of the holding bore of the inner ring. This makes it possible to tolerate a radial play of approximately 0.75 mm between the guide collar and the inner ring. The elastic holding element also equalizes a negative influence on the radial play of the rolling bearing. Said negative influence would occur, for example, if the spacer sleeve were to be pressed into the holding bore of the inner ring with an overlap.

Further advantageous embodiments of the invention are described in the following subclaims.

It emerges from claims 2 and 3 that the holding element is to be formed as a slotted holding ring or as a plastic O-ring. These can be produced in a particularly simple manner or are available cost-effectively on the market as bought-in parts in any desired size. In addition, assembly is cost-effective, since the holding elements can be inserted into the recess in a simple manner.

According to a further feature of the invention according to claim 4, in the region of its screw head, the fastening screw is to be centered by means of a guide step which is fitted into the holding bore of the inner ring. This simplifies assembly of the deflecting roller on the stop face of an engine.

According to a further feature of the invention according to claim 5, a shoulder of the spacer sleeve is to be supported against an end side of the inner ring. This embodiment of the spacer sleeve provides precise transmission of axially acting forces from the fastening screw via the inner bearing ring, the spacer sleeve and the stop face of the engine.

It emerges from claim 6 that the spacer sleeve is produced from an aluminum material. As a result of the relatively low specific weight of the aluminum material, this contributes to a weight saving, even if only slight.

Finally, according to a final feature of the invention according to claim 7 it is provided that the rolling bearing is formed as a single-row deep groove ball bearing which is sealed off at both sides and whose ball bearings are guided in a cage. Standard versions of deep groove ball bearings of said type are available cost-effectively as bought-in parts in a very wide variety of sizes.

The invention is described in more detail on the basis of the following exemplary embodiment.

### BRIEF DESCRIPTION OF THE DRAWING

The single FIGURE shows a longitudinal section through a deflecting roller according to the invention.

### DETAILED DESCRIPTION OF THE DRAWING

The deflecting roller 1 shown in the single FIGURE comprises the rolling bearing 2 which is embodied as a deep groove ball bearing and the outer ring 3 of which is enclosed by a plastic annular body 4, wherein the radially inwardly directed projection 4.1 of the annular body 4 engages in the associated recess 3.1 of the outer ring 3. This ensures that the annular body 4 cannot slide off the outer ring 3 in the axial direction. A traction mechanism, for example a flat belt, (not illustrated) bears against the lateral surface 4.2 of the annular body 4. The rolling bearing 2 also includes its inner ring 5, the ball bearings 7 which are guided in the cage 6, and the two seals 8, 9 which are fixedly connected to the outer ring 3.

The deflecting roller 1 also includes the spacer sleeve 10, the guide collar 10.5 of which is held by the holding bore 5.1 of the inner ring 5. A recess 10.4 in the form of a peripheral groove is provided in the guide collar 10.5, or its lateral surface 10.1, with the elastic holding element 11 being inserted into said recess 10.4. The spacer sleeve 10 also includes its shoulder 10.3, against which the end side (not denoted) of the inner ring 5 of the rolling bearing 2 bears. The spacer sleeve 10 accordingly has a stepped profile, with the lateral surface 10.1 of the guide collar 10.5 having a smaller diameter, as viewed in cross section, than the remainder of the lateral surface 10.2 of the spacer sleeve 10.

Finally, the complete deflecting roller 1 also includes the fastening screw 12, whose shank 12.1 is provided at the right-hand side with a thread (not illustrated in more detail) and is connected at the left-hand side to the screw head 12.1. The latter merges into the guide step 12.3 which is enclosed by the holding bore 5.1 of the inner ring 5, so that the fastening screw 12 is centered in a simple manner when it is inserted into the rolling bearing 2.

The essence of the invention is that the deflecting roller 1 is combined with the spacer sleeve 10 to form a captively held assembly which is delivered to the end consumer without an associated fastening screw 12. Assembly takes place such that, initially, the elastic holding element 11 is inserted into the recess 10.4 of the guide collar 10.5 of the spacer sleeve 10. The insertion of the spacer sleeve 10 into the holding bore 5.1 of the inner ring 5 in the axial direction ends when the shoulder 10.3 of said spacer sleeve 10 bears against the right-hand end face of the inner ring 5. The spacer sleeve 10 is securely held in the rolling bearing 2 by virtue of the holding element 11 springing outward, wherein the diameter of the guide collar 10.5 is slightly smaller than the diameter of the holding bore 5.1 of the inner ring. In this way, the inner ring 5 cannot be expanded, that is to say the bearing play of the rolling bearing 2 remains unaffected. The deflecting roller 1, including the spacer sleeve 10 which is held against it, is fastened to the screw-on surface (not illustrated) of the engine by virtue of the fastening element 12 being inserted into the rolling bearing 2 until the screw head 12.2 bears against the left-hand end face of the inner bearing ring 5. The deflecting roller 1 is then pressed in the axial direction by means of the thread of the shank 12.1 being screwed into the holding bore (not illustrated) of the screw-on surface, with force being transmitted from the screw head 12.2 to the screw-on surface on the engine via the inner bearing ring 5 and the shoulder 10.3.

### LIST OF REFERENCE SYMBOLS

1 Deflecting roller

2 Rolling bearing

3 Outer ring

3.1 Recess

4 Annular body

4.1 Projection

4.2 Lateral surface

5 Inner ring

5.1 Holding bore

6 Cage

7 Ball bearing

8 Seal

9 Seal

10 Spacer sleeve

10.1 Lateral surface

10.2 Lateral surface

10.3 Shoulder

10.4 Recess

10.5 Guide collar

11 Holding element

12 Fastening screw

12.1 Shank

12.2 Head

12.3 Guide step

1. A deflecting roller for a traction mechanism drive, composed of an annular body, against the lateral surface of which a traction mechanism, in particular a belt, bears, having a rolling bearing which is composed of an inner ring and an outer ring, wherein the outer ring is enclosed by a holding bore of the annular body, and the deflecting roller is fixed to a screw-on surface by means of a fastening screw which extends through a holding bore of the inner ring and a holding bore of a spacer sleeve, wherein the distance between the screw-on surface and the deflecting roller is determined by the axial extent of the spacer sleeve which is held against the deflecting roller by means of a transport securing means, wherein a guide collar of the spacer sleeve is held by the holding bore of the inner ring, and the guide collar has a recess in which an elastic holding element is inserted, said elastic holding element bearing against the holding bore of the inner ring under preload.

2. The deflecting roller (1) as claimed in claim 1, wherein the holding element is formed as a slotted holding ring.

3. The deflecting roller f as claimed in claim 1, wherein the holding element is formed as a plastic O-ring.

4. The deflecting roller 1 as claimed in claim 1, wherein, in the region of its screw head, the fastening screw is centered by means of a guide step which is fitted into the holding bore of the inner ring.

5. The deflecting roller as claimed in claim 1, wherein a shoulder of the spacer sleeve is supported against an end side of the inner ring.

6. The deflecting roller as claimed in claim 1, wherein the spacer sleeve is produced from an aluminum material.

7. The deflecting roller as claimed in claim 1, wherein the rolling bearing is formed as a single-row deep groove ball bearing which is sealed off at both sides and whose ball bearings are guided in a cage.
